(19) United States
(12) Patent Application Publication
(10) Pub. No.: US 2024/0334378 A1
(43) Pub. Date: Oct. 3, 2024

(54) SIDELINK POSITIONING CONFIGURATIONS

(71) Applicant: ZTE Corporation, Shenzhen (CN)

(72) Inventors: Juan LIU, Shenzhen (CN); Chuangxin JIANG, Shenzhen (CN); Mengzhen Li, Shenzhen (CN); Qi Yang, Shenzhen (CN); Junpeng Lou, Shenzhen (CN)

(73) Assignee: ZTE Corporation, Shenzhen (CN)

(21) Appl. No.: 18/740,354

(22) Filed: Jun. 11, 2024

Related U.S. Application Data
(63) Continuation of application No. PCT/CN2022/123444, filed on Sep. 30, 2022.

(51) Int. Cl. H04W 64/00; H04W 72/25; H04W 74/0833

(52) U.S. Cl. CPC H04W 64/00; H04W 72/25; H04W 74/0833

(57) ABSTRACT

Techniques and methods are described to for SL PRS positioning configuration design and PRACH based positioning scheme design in a wireless communication environment. Multiple examples of wireless communication methods for grouping SL-PRS, designing SL-PRS configuration information, and transmitting PRACH based configuration information are disclosed.

### CROSS-REFERENCE TO RELATED APPLICATIONS

This application is a continuation of International Patent Application No. PCT/CN2022/123444, filed on Sep. 30, 2022, the contents of which are incorporated herein by reference in their entirety.

### TECHNICAL FIELD

This disclosure is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

This application discloses techniques for sidelink positioning, configuring sidelink positioning signals, receiving sidelink positioning signals, transmitting sidelink positioning signals, and/or the like.

A wireless communication method includes communicating, by a first wireless communication device, a sequence of sidelink positioning reference signals (SL-PRS) to a second wireless communication device, or from the first wireless communication device to a third wireless communication device through a fourth wireless communication device, wherein the sequence is one of M SL-PRS sequence(s), wherein the M sequence(s) are divided into N group(s) based on a grouping method, wherein both M and N are positive integers, wherein each of the M SL-PRS has an identification information, wherein each of the N group(s) has a group identification.

In some embodiments, at least one of following is satisfied: the M is 4096, M is not divisible by N, N is less than M, or N is equal to M.

In some embodiments, the grouping method is associated with at least one of: 1) pathloss, 2) message size, buffer size, 3) reference signal received power (RSRP), 4) reference signal received path power (RSRPP) and/or 5) priority.

In some embodiments, the method further comprising, retransmitting a SL-PRS sequence information based on a request from the second wireless communication device or the third communication device, or based on more than a certain time range/window.

In some embodiments, the retransmitting is based on a SL-PRS sequence attempt corresponding to a first transmission SL-PRS sequence.

In some embodiments, the retransmitting is based on a SL-PRS sequence attempt corresponding to a first transmission group identification.

In some embodiments, the communicating comprises using at least one of: a send, a receive, a broadcast, a unicast, a request, a response, a forward, an exchange or a groupcast.

The application further discloses a wireless communication method, comprising communicating a configuration information for sidelink positioning.

In some embodiments, the communicating is from a first wireless communication device to a second wireless communication device, or from the first wireless communication device to a third wireless communication device through a fourth wireless communication device.

In some embodiments, the communication method further comprising, receiving a request from the second wireless communication device or from the third wireless communication device for the configuration information.

In some embodiments, the communication method further comprising transmitting a response from the first wireless communication device to the second wireless communication device or to the third wireless communication device, wherein the response is related to a request received by the first wireless communication device.

In some embodiments, the configuration information comprising at least one of: 1) resource ID, 2) sequence group, 3) a list of sorted resources, 4) an index indicating an availability of a specific time duration, 5) an index indicating a preference degree of the specific time duration, 6) an index indicating the availability of a logical specific time duration, 7) an index indicating the preference degree of the logical specific time duration, 8) an index indicating a group of specific time durations occupied by a plurality of controlling signals, 9) an index indicating the controlling signals, 10) sequence ID, 11) SL-PRS pattern, 12) S-PRS parameter(s) and/or 13) DMRS ID(s).

In some embodiments, the configuration information does not comprise at least one of: 1) an index indicating an availability of an absolute specific time duration, 2) an index indicating a preference degree of the absolute specific time duration, 3) an index indicating an availability of a logical specific time duration, 4) an index indicating the preference degree of the logical specific time duration, and/or 5) an index indicating absolute specific time duration.

In some embodiments, the controlling signals are one of: 1) a high layer signaling, RRC, MAC CE, and/or SCI.

In some embodiments, the specific time duration is at least one of: slot, symbol or a certain time domain.

In some embodiments, the configuration information is transmitted in a plurality of symbols in time domain.

In some embodiments, a first symbol and/or a second symbol of the plurality symbols are used for performing channel access procedure(s).

In some embodiments, the configuration information is transmitted through at least one controlling signaling information.

In some embodiments, the configuration information is associated with one or more configuration(s).

In some embodiments, the configuration information is in a shared Channel Occupancy Time (COT).

In some embodiments, the configuration information is in a separate Channel Occupancy Time (COT).

In some embodiments, some of the configuration information share at least one of: 1) a bandwidth information, 2) frequency layer, 3) comb size, 4) PRS frequency offset, 5) period, 6) PRS ID, 7) gap, 8) SL-PRS repetition number, 9) the time domain of SL-PRS, and/or 10) priority of the SL-PRS.

In some embodiments, the configuration information is associated with a SL-PRS pattern.

In some embodiments, the SL-PRS pattern is associated with at least one of: SL-PRS repetition number or comb size.

In some embodiments, the SL-PRS repetition number or comb size is indicated by a control signaling.

The application discloses a wireless communication method, comprising: communicating a configuration information or measurement result related to physical random access channel (PRACH) between a first wireless communication device and a second wireless communication device, or between the first wireless communication device and a third wireless communication device through a fourth wireless communication device.

In some embodiments, the first wireless communication device, the second wireless communication device, the third communication device, and/or the fourth communication device is one of: 1) a user equipment (UE), 2) a network node, 3) a base station, 4) a local server, 5) a transmission/reception point (TRP), and/or 6) a Location Management Function (LMF).

In some embodiments, the configuration information comprises at least one of: 1) RACH preamble, 2) RACH preamble length, 3) RACH type, 4) PRACH occasion(s), 5) a preamble index, 6) a preamble SCS, 7) the target power for PRACH, 8) a corresponding RA-RNTI, 9) a PRACH resource, 10) PRACH preamble format, 11) time resources, 12) frequency resources, 13) index to logical root sequence table, cyclic shift (N_cs), 14) set type, 15) parameter(s) for determining the root sequences and their cyclic shifts in the PRACH preamble sequence set or configuration of physical random access channel (PRACH) transmission parameters, or 16) a UL/SUL indicator field value for PRACH transmission.

In some embodiments, the RACH type comprising at least one of: 1) an indication to perform a type-1 random access procedure, and/or 2) an indication to perform a type-2 random access.

In some embodiments, the configuration information is a positional signal.

In some embodiments, the positional signal is used for RRC inactive state.

In some embodiments, the measurement result comprising at least one of 1) RSRP/RSRPP measure, 2) an identification information of a wireless device and/or, 3) C-RNTI.

In some embodiments, the set type comprising at least one of: (unrestricted, restricted set A, or restricted set B.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWINGS

FIG. 1 provides an exemplary diagram of valid resource for SL transmission.

FIG. 2 provides exemplary diagram that illustrates SL PRS resource.

FIGS. 3-5 provide exemplary diagrams of PRACH based configuration transmission.

FIG. 6 shows an exemplary block diagram of a hardware platform that may be a part of a network device or a communication device.

FIG. 7 shows an example of wireless communication including a base station (BS) and user equipment (UE) based on some implementations of the disclosed technology.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### Initial Disclosure

The sidelink of SI had been approved in RAN #94 for Rel-18 positioning.

In RAN1 and RAN2, study and evaluate performance and feasibility of potential solutions are proposed for SL positioning, considering relative positioning, ranging and absolute positioning.

Evaluate bandwidth requirement needed to meet the identified accuracy requirements as discussed in RAN1.

Study of positioning methods, such as TDOA, RTT, AOA/D, etc., including combination of SL positioning measurements with other RAT dependent positioning measurements, e.g., UE based measurements.

Study of sidelink reference signals for positioning purposes from physical layer perspective, including signal design, resource allocation, measurements, associated procedures, reusing existing reference signals, procedures, etc. from sidelink communication and from positioning as much as possible.

RAN2 contains study of positioning architecture and signaling procedures, e.g., configuration, measurement reporting, to enable sidelink positioning covering both UE based and network-based positioning, including coordination and alignment with RAN3 and SA2 as required.

When the bandwidth requirements have been determined and the study of sidelink communication in unlicensed spectrum has progressed, it can be reviewed whether unlicensed spectrum can be considered in further work.

### Embodiment 1 (Positioning Reference Signal (PRS) ID Group)

Assume that a sidelink (SL) positioning reference signal (PRS) contains M PRS sequences, where M is an integer.

One existing problem is how to configure and group the M PRS sequence.

In one example, the M PRS sequences are grouped into N subgroups, where N is an integer less or equal to M.

The grouping method can be predefined or preconfigured.

In one example, N is divisible by M. For example, for M=4096, N can be 2 or 2048.

In another example, N is not divisible by M. For example, for M=4096, N can be 3 or 5.

In another example, M is configured as 4096.

In another example, N can be determined to be associated with at least one of the following: the positioning methods, pathloss, message/buffer size, RSRP, RSRPP, and/or priority.

In another example, a single PRS sequence within the M PRS sequences cannot associate with more than one of the N subgroups. In other words, any two of the N subgroups containing PRS sequences have no overlap with each other.

### Embodiment 2 (PRS ID Group with Priority)

The proposed ID grouping methods as disclosed in Embodiment 1 can further include priority associated with the subgroups.

In one example, each of the N subgroups is associated with a priority.

In another example, N is configured to be 8.

In another example, the number of PRS sequences in each N subgroups is the same. For example, for M=4096 and N=8, each of the 8 subgroups contains 512 PRS sequences.

In another example, the number of PRS sequences in N subgroups can be different. In other words, there exists at least one pair of N subgroups that contain a different number of PRS sequences.

In one example, there is a retransmission of the PRS sequences if some of the M PRS transmission failed.

In one example, the retransmission can be based on the PRS ID in the previous transmission(s), i.e., an ID information associated with any of the M PRS sequences. For example, a retransmission of PRS sequence 1 can adopt the same PRS ID of PRS sequence 1 in the previous transmission(s). In one example, the re-transmission of a PRS sequence may have the PRS ID as the first previous transmission of the PRS sequence. In another example, the retransmission of a PRS sequence may have the same PRS ID as the latest previous transmission of the PRS sequence.

In another example, the retransmission can be based on the PRS group ID in the previous transmission(s), i.e., an ID information associated with any of the N subgroups. For example, a retransmission of PRS sequence 1 can adopt the same PRS group ID of PRS sequence 1 in the previous transmission(s). In one example, the retransmission of a PRS sequence may have the PRS ID as the first previous transmission of the PRS sequence. In another example, the retransmission of a PRS sequence may have the same PRS ID as the latest previous transmission of the PRS sequence.

### Embodiment 3 (Exchange Resource Configuration)

This embodiment discloses multiple proposed solutions for a design of exchanging resource configuration information among multiple wireless devices.

In one example, two wireless devices transfer the resource configuration information to each other.

In another example, the two wireless devices communicate and exchange the configuration information through a third wireless device.

In another example, a wireless device sends out a request for the configuration information. Another wireless device, e.g., a UE, after receiving the request, responds to the request before sending out a confirmation information. Alternatively, the other wireless device sends out the configuration information without responding to the request received.

The transference of the configuration information can be through a control signaling.

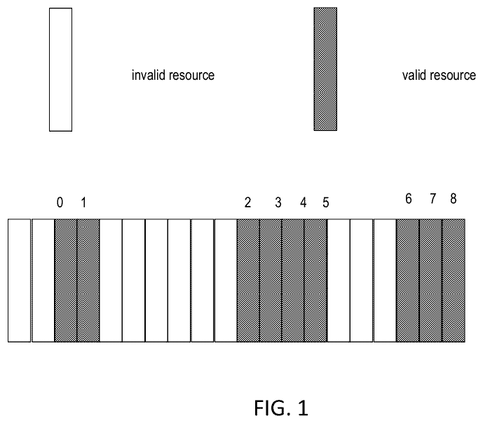

In one example, the configuration information comprises at least one of the following information: resource ID, sequence ID, sequence group, list of resources with sorting, a valid/invalid/preferred/unpreferred specific timed duration index, a valid/invalid/preferred/unpreferred logical specific time duration index (as disclosed in FIG. 1), the symbols occupied by control signaling, the number of control signaling per configuration or DMRS ID(s).

In another example, the configuration information does not comprise at least one of: valid/invalid/preferred/unpreferred absolute specific time duration index, absolute specific timed duration index.

In another example, the control signaling can be one of the following, a high layer signaling, RRC, MAC CE, or SCI.

In another example, the control signaling can be transmitted to occupy one or more consecutive specific timed duration(s) in time domain.

In another example, the specific timed duration may be slot, symbol or certain time duration.

### Embodiment 4 (PRS Repetition)

TABLE 1

| | Symbol number within the downlink PRS resource l − lₛₜₐᵣₜ^{PRS} | | | | | | | | | | | |
|---|---|---|---|---|---|---|---|---|---|---|---|---|
| K_{comb}^{PRS} | 0 | 1 | 2 | 3 | 4 | 5 | 6 | 7 | 8 | 9 | 10 | 11 |
| 2 | 0 | 1 | 0 | 1 | 0 | 1 | 0 | 1 | 0 | 1 | 0 | 1 |
| 4 | 0 | 2 | 1 | 3 | 0 | 2 | 1 | 3 | 0 | 2 | 1 | 3 |
| 6 | 0 | 3 | 1 | 4 | 2 | 5 | 0 | 3 | 1 | 4 | 2 | 5 |
| 12 | 0 | 6 | 3 | 9 | 1 | 7 | 4 | 10 | 2 | 8 | 5 | 11 |

This embodiment discloses multiple proposed solutions of designing a frequency offset repetition transmission scheme in a SL PRS transmission to increase the probability of successfully receiving the exchanged configuration information.

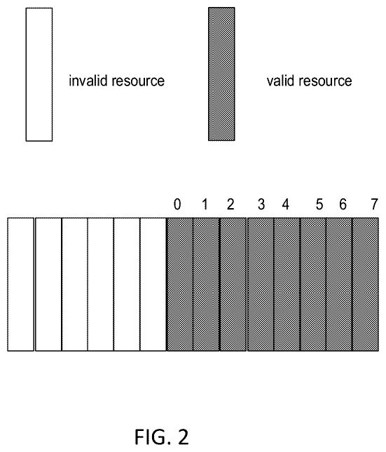

FIG. 2 illustrates an example of SL PRS resource scheme.

As disclosed in FIG. 2, there are both valid and invalid resources contained in the SL PRS resource. For example, the logical symbols {0,1,2,3,4,5,6,7} are valid resource for use, as indicated by FIG. 2.

In one proposed scheme design, a parameter indicating repetition is involved to create a SL PRS transmission scheme.

In one example, a repetition scheme can depend on both the parameter indicating the repetition and a comb size.

For example, in a transmission environment as indicated by FIG. 2, if the comb size or K_{comb}^{PRS}=4, a repetition parameter is 2, the repetition of frequency offset scheme can be designed as {0,0,2,2,1,1,3,3} for the valid symbols {0,1,2,3,4,5,6,7} respectively.

In an example where the comb size or K_{comb}^{PRS}=2 and a repetition parameter is 4, the frequency offset schemed can be designed as {0,0,0,0,1,1,1,1} for the valid symbols {0,1,2,3,4,5,6,7}, respectively.

In one example, the repetition parameter is one or multiple default values.

In another example, the repetition parameter is configured through a control signaling.

### Embodiment 5

If a communication device is configured with {L_{PRS}, K_{comb}^{PRS}}={4, 2}, the first parameter is the SL PRS symbol length, the second parameter is the Comb Size, the time resource is {0,1,2,3,4,5,6,7}, as disclosed in FIG. 2.

Alternatively, a communication device can be configured with a 3-part parameter set.

In one example, the front part can be used for LBT or AGC.

In another example, the middle part can be used for PRS signal transmission.

In another example, the last part may be used for gap.

Alternatively, the first two valid symbol(s) can be used for LBT symbol/AGC symbol/(LBT+AGC symbol).

Alternatively, the first valid symbol can be used for LBT.

Alternatively, the second valid symbol is used for AGC.

Alternatively, the resource {2,3,4,5} are with PRS frequency offset {0,1,0,1}, respectively.

Alternatively, the resource {6,7} are with PRS frequency offset {0}.

Alternatively, the resource {6,7} do not transmit (PRS) signals.

### Embodiment 6 (Cyclic Prefix Extension Design for SL PRS)

Cyclic prefix (CP) refers to the prefixing of a symbol, with repetition of the end in wireless communication systems.

There is a time gap associated with the sidelink subcarrier spacing (SL SCS).

To better utilize the CP resource, this embodiment discloses a plurality of CP extension scheme design for SL PRS.

In one example, the CP extension has the same information as the adjacent symbol, e.g., a AGC symbol.

In another example, x symbol(s) are required for SL SCS of 15 kHz or 30 KHz; y symbol(s) for 60 kHz or 120 kHz; z symbol(s) for 480 kHz or 960 kHz; n symbol(s) for 15 kHz*m where n, m, x, y, and z are integers. In another example, x=1, y=2, z=3.

### Embodiment 7 (One Control Signaling with One or Multiple PRS Configuration Information)

PRS configuration can be transmitted through control signaling.

This embodiment discloses multiple methods of designing controlling signaling.

In one example, one control signaling is associated with one or more PRS configuration(s)/instance(s).

In one example, the one or more PRS configuration information may not be in a shared channel occupancy time (COT).

In another example, the one or more PRS configuration or PRS instances can be in a shared COT.

In another example, the number of the PRS configuration information or the PRS instances can be indicated in the control signaling.

The controlling signaling may contain a group of information shared by all the PRS instances. For example, the controlling signaling may contain at least one of the following information: the bandwidth/frequency layer/comb size/PRS frequency offset/period/PRS ID/gap/priority of the PRS. That information is the same for the one or more PRS configuration(s) information or PRS instances.

### Embodiment 8 (PRACH Based Positioning Design)

This embodiment discloses several positioning design methods applied in physical random access channel (PRACH).

Two communication devices may transfer the PRACH configuration information to each other, or through a third communication device.

The communication device can be at least one of the following: user equipment (UE), a network node, a base station, a local sever, a Transmission/Reception Point (TRP) or a Location Management Function (LMF).

In one example, PRACH configuration information may contain at least one of the following information: RACH preamble, RACH preamble length, RACH type, PRACH occasion(s), a preamble index, a preamble SCS, P_{PRACH,target}, a corresponding RA-RNTI, a PRACH resource, PRACH preamble format, time resources, frequency resources, index to logical root sequence table, cyclic shift (N_{CS}), set type (unrestricted, restricted set A, or restricted set B), parameter(s) for determining the root sequences and their cyclic shifts in the PRACH preamble sequence set or configuration of physical random access channel (PRACH) transmission parameters, the UL/SUL indicator field value for PRACH transmission.

In one example, the RACH type comprises at least one of the following: an indication to perform a type-1 random access procedure, or a type-2 random access.

In one example, the PRACH/preamble can be used as a positioning signal.

In another example, the PRACH/preamble can be used as positioning signal at least for RRC inactive state.

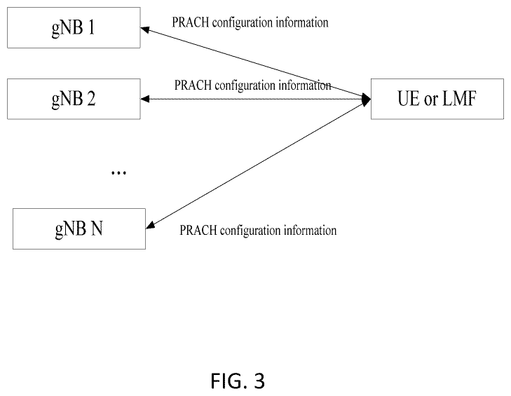

As disclosed in FIG. 3, one or more gNB(s) send/receive the PRACH configuration to/from UE or LMF.

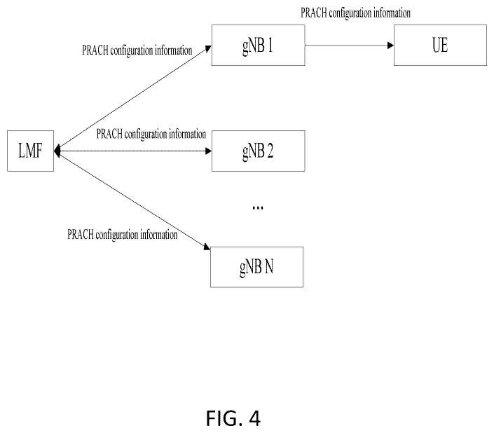

Alternatively, in another example as disclosed in FIG. 4, a LMF send a PRACH configuration information to one or more gNB(s), then the serving gNB send the PRACH configuration information to a UE.

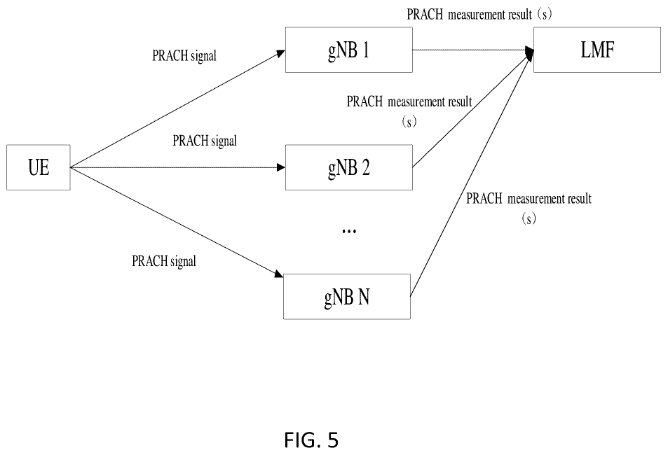

Alternatively, in another example as disclosed in FIG. 5, a UE sends a PRACH signal according to the PRACH configuration information to one or more gNB(s), and then the gNB(s) send the PRACH measurement result(s) to LMF.

In one example, PRACH measurement result(s) comprises at least one of: RSRP measure by gNB, UE ID, or Cell Radio Network Temporary Identify (C-RNTI).

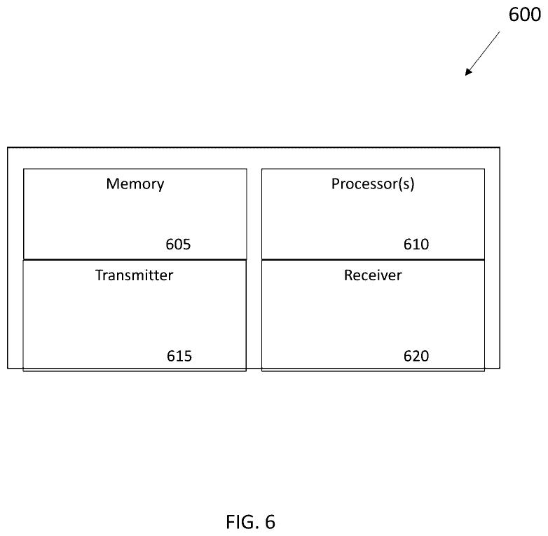

FIG. 6 shows an exemplary block diagram of a hardware platform 600 that may be a part of a network device (e.g., base station) or a communication device (e.g., a user equipment (UE)). The hardware platform 600 includes at least one processor 610 and a memory 605 having instructions stored thereupon. The instructions upon execution by the processor 610 configure the hardware platform 600 to perform the operations described in FIGS. 1 to 5 and 7 and in the various embodiments described in this patent document. The transmitter 615 transmits or sends information or data to another device. For example, a network device transmitter can send a message to user equipment. The receiver 620 receives information or data transmitted or sent by another device. For example, user equipment can receive a message from a network device.

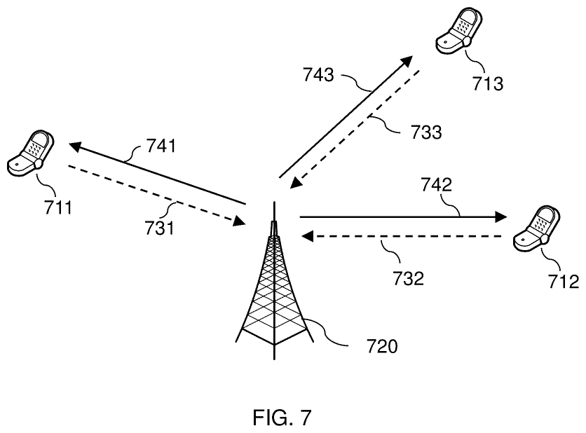

The implementations as discussed above will apply to a wireless communication. FIG. 7 shows an example of a wireless communication system (e.g., a 5G or NR cellular network) that includes a base station 720 and one or more user equipment (UE) 711, 712 and 713. In some embodiments, the UEs access the BS (e.g., the network) using a communication link to the network (sometimes called uplink direction, as depicted by dashed arrows 731, 732, 733), which then enables subsequent communication (e.g., shown in the direction from the network to the UEs, sometimes called downlink direction, shown by arrows 741, 742, 743) from the BS to the UEs. In some embodiments, the BS send information to the UEs (sometimes called downlink direction, as depicted by arrows 741, 742, 743), which then enables subsequent communication (e.g., shown in the direction from the UEs to the BS, sometimes called uplink direction, shown by dashed arrows 731, 732, 733) from the UEs to the BS. The UE may be, for example, a smartphone, a tablet, a mobile computer, a machine to machine (M2M) device, an Internet of Things (IoT) device, and so on.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A wireless communication method, comprising:
communicating a configuration information for a sidelink positioning,
wherein the communicating is from a first wireless communication device to a second wireless communication device, and
wherein the configuration information is transmitted through at least one controlling signaling information.

2. The method of claim 1, wherein the configuration information comprising resource ID, and/or a list of sorted resources.

3. The method of claim 1, wherein the at least one controlling signaling information is transmitted using a higher layer signaling, a radio resource control (RRC) signaling, or sidelink control information (SCI).

4. The method of claim 1, wherein the first wireless communication device is a user equipment (UE), and wherein the second wireless communication device is a Location Management Function (LMF).

5. The method of claim 1, wherein the communicating comprises sending the configuration information.

6. An apparatus for wireless communication, comprising a processor that when configured implements a method that causes the apparatus to:
communicate a configuration information for a sidelink positioning,
wherein the communicating is from a first wireless communication device to a second wireless communication device, and
wherein the configuration information is transmitted through at least one controlling signaling information.

7. The apparatus of claim 6, wherein the configuration information comprising resource ID, and/or a list of sorted resources.

8. The apparatus of claim 6, wherein the at least one controlling signaling information is transmitted using a higher layer signaling, a radio resource control (RRC) signaling, or sidelink control information (SCI).

9. The apparatus of claim 6, wherein the first wireless communication device is a user equipment (UE), and wherein the second wireless communication device is a Location Management Function (LMF).

10. The apparatus of claim 6, wherein the communicating comprises sending the configuration information.

11. A non-transitory computer-readable storage medium having code stored thereupon, the code, upon execution by a processor, causing the processor to implement a method, comprising:
communicating a configuration information for a sidelink positioning,
wherein the communicating is from a first wireless communication device to a second wireless communication device, and
wherein the configuration information is transmitted through at least one controlling signaling information.

12. The non-transitory computer-readable storage medium of claim 11, wherein the configuration information comprising resource ID, and/or a list of sorted resources.

13. The non-transitory computer-readable storage medium of claim 11, wherein the at least one controlling signaling information is transmitted using a higher layer signaling, a radio resource control (RRC) signaling, or sidelink control information (SCI).

14. The non-transitory computer-readable storage medium of claim 11, wherein the first wireless communication device is a user equipment (UE), and wherein the second wireless communication device is a Location Management Function (LMF).

15. The non-transitory computer-readable storage medium of claim 11, wherein the communicating comprises sending the configuration information.
